(19) United States
(12) Patent Application Publication
(10) Pub. No.: US 2022/0250080 A1
(43) Pub. Date: Aug. 11, 2022

(54) HEATER

(71) Applicant: LEX DIAGNOSTICS LTD, Royston (GB)

(72) Inventors: Justin Rorke Buckland, Cambridge (GB); Seoirse Murray, Royston (GB)

(21) Appl. No.: 17/630,468

(22) PCT Filed: Jul. 24, 2020
(86) PCT No.: PCT/EP2020/071059

§ 371 Date: Jan. 26, 2022

(30) Foreign Application Priority Data
Jul. 26, 2019 (EP) 19188688.6

(51) Int. Cl. B01L 7/00

(52) U.S. Cl. CPC B01L 7/52; B01L 2200/12; B01L 2300/1827; B01L 2200/147

(57) ABSTRACT

A heater for thermocycling to carry out PCR amplification. The heater comprises: a thermal diffusion layer having a reaction surface for transferring heat to a reaction cell; a heater track support layer having a back surface for cooling; an electrically conductive main heater track supported between the heater track support layer and the thermal diffusion layer; and four-terminal electrical contacts to the main heater track adapted to provide electrical connection for driving the main heater track and simultaneously sensing a resistance of the main heater track. The lateral dimensions of the reaction surface are greater than a thickness H of the heater, such that reaction surface area A>H².

The present invention relates to a heater for providing a variable temperature on a reaction surface of the heater.

One example process where such a heater is required is DNA amplification by the polymerase chain reaction (PCR), where the heater provides fast thermocycling to reduce the time for completion of PCR.

Prior art heaters are fabricated from electrically conductive tracks supported by an electrically insulating substrate. Prior art heaters are controlled using a separate temperature sensor to sense the heater temperature and a control algorithm and electronic drive circuit to modulate the electric drive to the heater.

In order to provide fast thermal response, the heater must have low heat capacity and the heater must be in close thermal contact with the reaction surface. In particular the thermal diffusion time from the heater element to the reaction surface must be less than the required temperature change response time, so the heater and reaction surface can only be separated by a thin layer.

Conventional heaters and temperature control systems have several disadvantages when trying to achieve fast response, precise temperature control and uniform temperature distribution.

For example, use of a temperature sensor separated from the heater introduces a delay in the heater control loop which can reduce the response speed or introduce temperature overshoot.

Additionally, temperature non-uniformity results from heat generation within spatially separated resistive heating tracks located close to the reaction surface, resulting in hotter regions directly above heater tracks and colder regions above the gaps between heater tracks. Temperature non-uniformity on the reaction surface is undesirable as it may reduce the efficiency and specificity of the PCR amplification. Therefore an objective of the invention is to increase the temperature uniformity and references to improved temperature uniformity and increased temperature uniformity are equivalent.

Temperature non-uniformity at the reaction surface can be reduced by using narrower tracks and gaps, but this complicates fabrication using standard printed circuit board techniques. Temperature non-uniformity at the reaction surface can also be reduced by increasing the distance between the heater tracks and the reaction surface, but this increases the thermal diffusion time from heater to reaction surface and slows the heater response.

Temperature non-uniformity also results from edge effects, where the temperature of the heater is reduced at the edges due to lateral heat flow. In prior art, edge effects are reduced by design of heater track patterns with increased heat output near the edge of the heater, for example by reducing the track and gap widths of the heater element in these areas. However this approach needs to be carefully designed for a particular operating temperature and reaction surface geometry and thermal load, and may be difficult to achieve if the heater track and gap widths are already close to the minimum values practical for standard fabrication processes. It is also desirable to minimise the heater track and gap widths in the central area of the heater to minimise temperature non-uniformity and therefore it is difficult to further reduce the heater track and gap widths near the edges of the heater.

In order to allow rapid cooling when the heater power is reduced, a heater may be connected to a heat sink via a controlled thermal resistance. However the heater temperature uniformity will depend on the uniformity of the thermal contact between the heater and heat sink. In particular, any air gaps between the heater and heat sink can introduce substantial thermal resistance and temperature non-uniformity.

In view of the above problems and objectives, the present invention provides a heater for thermocycling to carry out PCR amplification. The heater comprises: a thermal diffusion layer having a reaction surface for transferring heat to a reaction cell; a heater track support layer having a back surface for cooling; an electrically conductive main heater track supported between the heater track support layer and the thermal diffusion layer; and four-terminal electrical contacts to the main heater track adapted to provide electrical connection for driving the main heater track and simultaneously sensing a resistance of the main heater track. The lateral dimensions of the reaction surface are greater than a thickness H of the heater, such that reaction surface area A>H².

Preferably, the main heater track comprises a central region comprising a plurality of substantially parallel track sections having widths W_{track} and separated by gaps of width W_{gap}, wherein the thickness H_{D} of the thermal diffusion layer is less than a minimum width of the track sections W_{track} or less than a minimum gap width W_{gap}, where W_{track} or W_{gap} are evaluated in the central region of the main heater track. This means that the main heater track can be manufactured using PCB manufacturing techniques. This also means that the heater is thin enough for many applications requiring rapid temperature change.

Preferably, the gap width W_{gap} and/or the width of the track sections W_{track} is lower for a track section near an edge of the main heater track than for a track section in the central region of the main heater track. This increases temperature uniformity in the central region of the main heater track.

Preferably, the heater further comprises: a guard heater track between the heater track support layer and the thermal diffusion layer, the guard heater track substantially surrounding the main heater track; and two further electrical contacts to the guard heater track independent from the four-terminal electrical contacts to the main heater track. This inhibits lateral heat flow and increases temperature uniformity in the plane of the main heater track.

Preferably, the heater track support layer has a thermal resistance×area product in the range 1×10⁻⁴ to 1×10⁻² K·m²/W and more preferably in the range 3×10⁻⁴ to 3×10⁻³ K·m²/W.

Preferably, the heater further comprises a reaction surface heat spreader layer located in contact with or within one of the thermal diffusion layer or the heater track support layer. This improves temperature uniformity at the reaction surface.

Preferably, the reaction surface heat spreader layer is more thermally conductive, has a greater lateral thermal conductivity and has a lower heat capacity than the one of the thermal diffusion layer or the heater track support layer.

Preferably, the reaction surface heat spreader layer is located within the heater track support layer at a distance Lₛ from the main heater track, wherein Lₛ is less than 20% of the minimum of the heater track width W_{rack} and heater gap width W_{gap} evaluated in the central region. This further improves temperature uniformity at the reaction surface.

Preferably, a back surface heat spreader layer is located on the back surface. In addition to improving temperature uniformity at the reaction surface, this improves thermal contact with any heat sink adjacent to the back surface.

Preferably, the heater further comprises a heat sink in contact with the back surface. This has the effect of reducing the temperature of the heater when the heater is not being driven.

In another aspect, the present invention provides a single use consumable comprising a heater and a reaction cell arranged in contact with the reaction surface.

In another aspect, the present invention provides a method of operating a heater or a variable temperature reactor, comprising driving the main heater track, simultaneously sensing a resistance of the main heater track, and calculating a temperature of the main heater track based on the sensed resistance.

Preferably, the method comprises performing feedback-based driving of the main heater track according to a sequence of temperature set points for the main heater track to cycle the temperature of the reaction surface to carry out PCR amplification.

Preferably, the method further comprises driving the guard heater track to provide a higher heat output per unit area than the main heater track.

Preferably, the heater or single use consumable as previously described further comprises a control circuit configured to perform a method as previously described.

Examples of the present invention will now be described with reference to the accompanying drawings, in which:

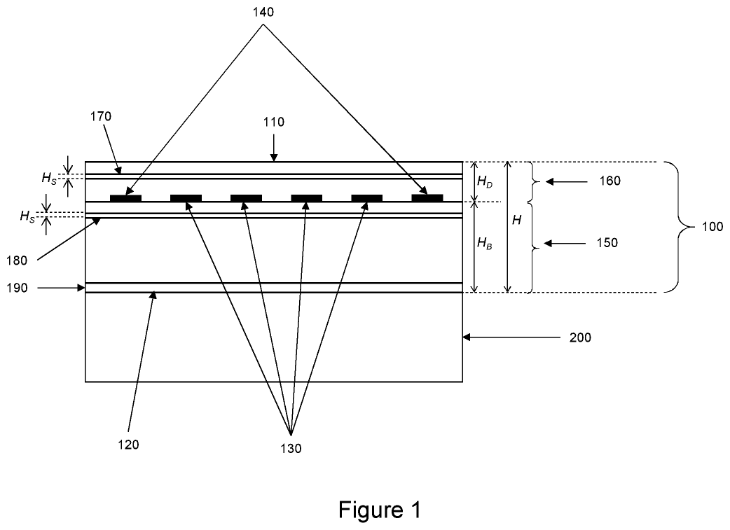

FIG. 1 shows a schematic cross-section view of an embodiment of the invention comprising a heater and a heat sink;

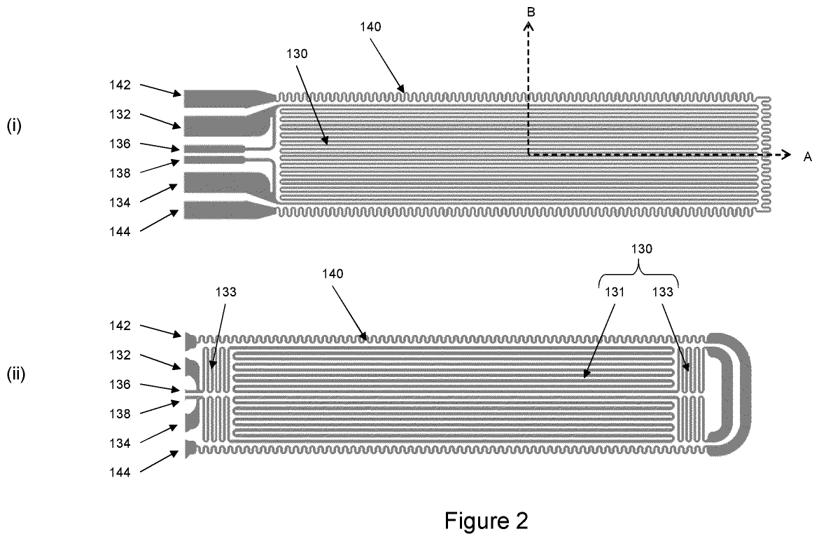

FIG. 2 shows two examples of schematic layouts of heater tracks and electrical connections in the heater of the embodiment;

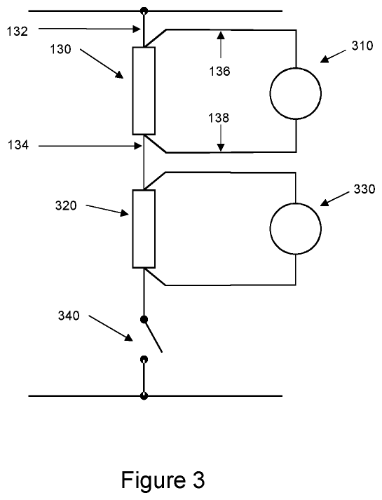

FIG. 3 schematically illustrates an electronic circuit which can be used for driving the heater track;

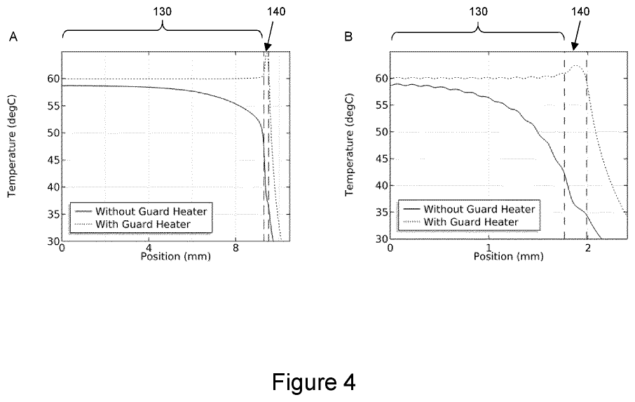

FIGS. 4A and 4B shows simulated temperature distributions for a guard heater according to an embodiment of the invention, and comparison with temperature distributions without a guard heater;

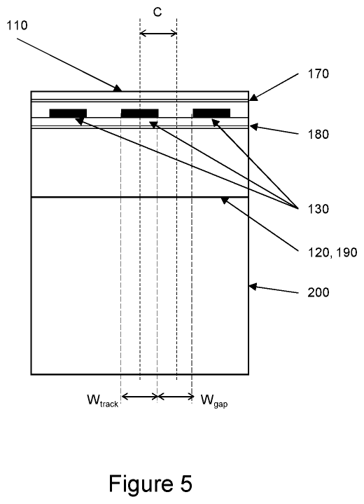

FIG. 5 shows another schematic cross-section view of the heater of the embodiment;

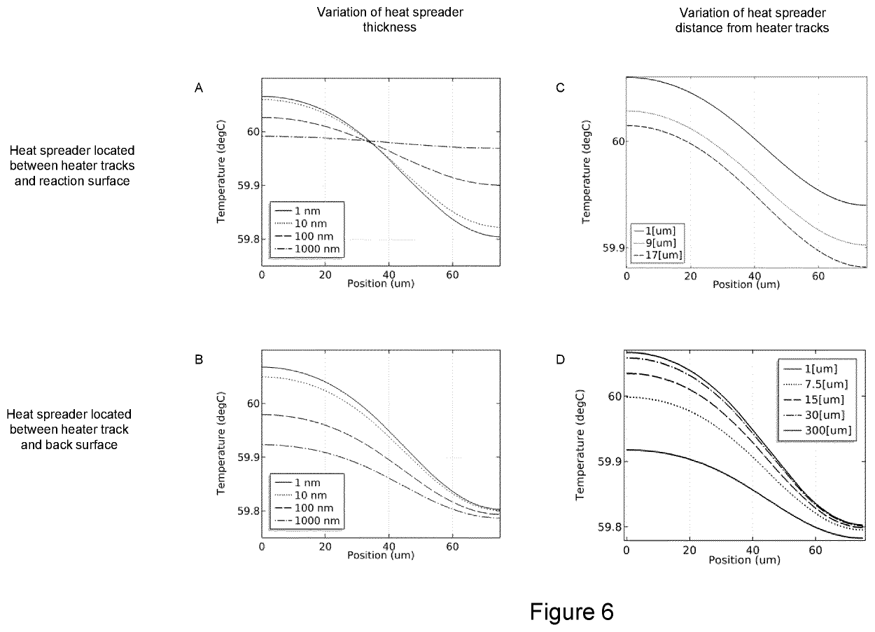

FIGS. 6A and 6B show simulated temperature distributions with heat spreaders of varying thickness and two different locations according to embodiments of the invention; FIGS. 6C and 6D show simulated temperature distributions with heat spreaders of varying position relative to the heater tracks;

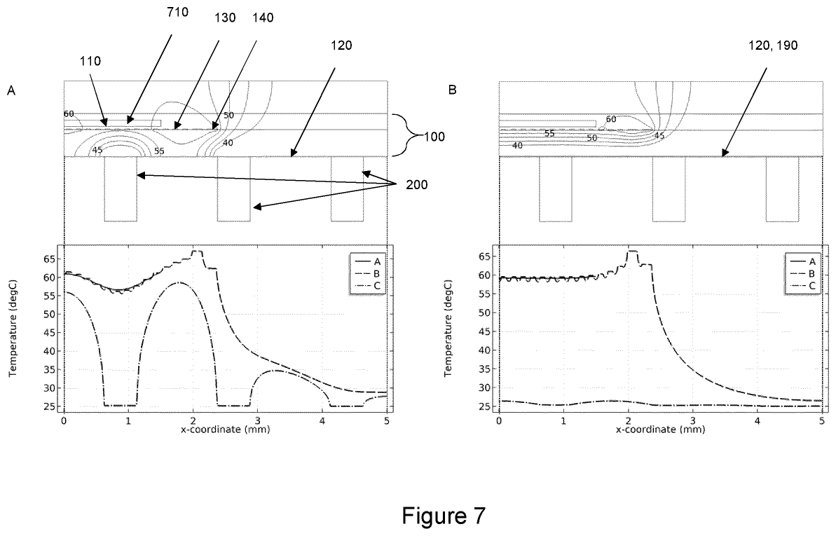

FIGS. 7A and 7B show simulated temperature distributions with and without a back surface heat spreader according to embodiments of the invention;

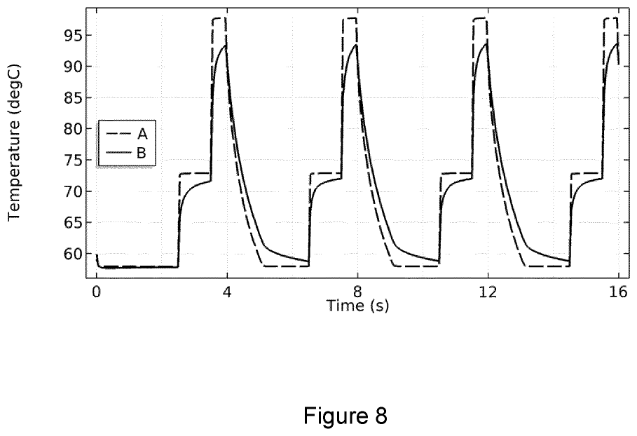

FIG. 8 shows variation of heater track temperature and reaction surface temperature during PCR thermocycling for a heater according to an embodiment of the invention;

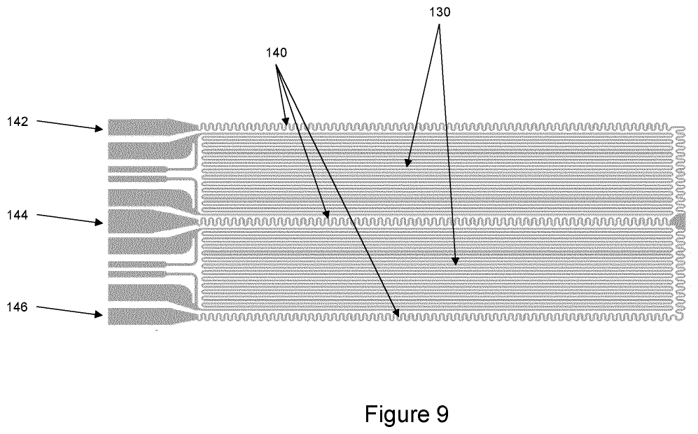

FIG. 9 shows an alternative schematic layout of resistive heating tracks in a heater 100 according to the invention;

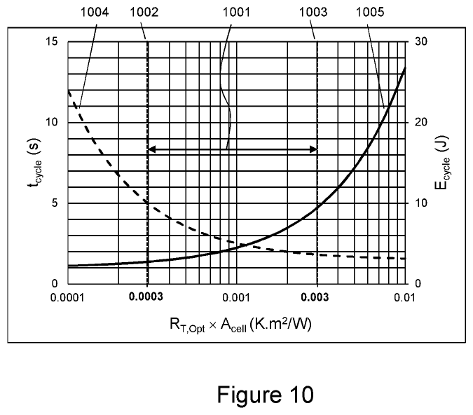

FIG. 10 shows an example range of thermal resistance when a hold step is included in a thermal cycle.

We describe below an example heater suitable for carrying out thermal cycling for PCR amplification. It is desirable to carry out thermal cycling at a speed fast enough that the time required for temperature changes does not account for the majority of the total time for thermocycling. The total time for thermocycling is the sum of the time for temperature changes and the time for reactions, and the slowest part of the PCR reaction is the extension phase, which requires approximately 1 s or more for a typical sequence length of 100 base pairs. Therefore we target a time of <1 s for temperature ramping. The target temperatures for PCR are typically between 60° C. and 95° C. so we need temperature ramp rates of 70° C./s or more for heating and cooling to reduce the temperature change time to 1 s. Much higher temperature ramp rates (200° C./s or higher) offer limited speed advantage as the total time required will be dominated by the reaction time and not the time required for temperature changes.

In one embodiment described below, a heater for carrying out fast thermal cycling has a temperature ramp rate of approximately 100° C./s without the disadvantages of conventional heaters and temperature control systems.

The heater may, for example, be arranged together with a reaction cell in a single use consumable. The single use consumable may be supplied with the necessary reagents and power to perform a single reaction test and then disposed of.

The heater contains the following elements: main heater tracks configured to enable simultaneous heating and temperature sensing via the heater track's temperature-dependent resistance; guard heater tracks substantially surrounding the main heater tracks; a thermal diffusion layer located between the heater tracks and the reaction surface; and a heater support layer located between the heater tracks and the back surface of the heater. The heater may also be provided with a heat sink in thermal contact with the back surface to allow rapid cooling of the heater when the heater drive power is reduced.

FIG. 1 shows a schematic cross-section of an embodiment of the invention comprising a heater 100 and a heat sink 200.

The heater 100 has a reaction surface 110 on one face and a back surface 120 on the opposite face. The reaction surface 110 is heated by the heater to provide a time-variable and substantially spatially-uniform temperature. The back surface 120 is in thermal contact with the heat sink 200 to allow cooling when the heater 100 is not driven.

In the following description, we define an axial direction to be perpendicular to the reaction surface and a lateral direction to be in the plane of the reaction surface.

The heater comprises a main heater track 130 for resistive heating of the reaction surface. However, it is desirable to limit lateral heat flow associated with temperature gradients and temperature non-uniformity across the reaction surface, which reduce the precision of temperature control.

In order to limit lateral heat flow within the area of the main heater track, the main heater track 130 is substantially surrounded by a guard heater track 140.

A guard heater track is an additional heater track located near the edge of a main heater track and driven to maintain a temperature close to or greater than a target temperature of the main heater track. The heat output per unit area of the guard heater track is higher than that of the main heater track to compensate for lateral heat loss. The guard heater track may be driven independently from the main heater. The main heater track 130 and the guard heater track 140 may, for example, be formed from a metal such as copper.

The main heater track 130 and the guard heater track 140 are located between a heater track support layer 150 and a thermal diffusion layer 160. The heater track support layer 150 may, for example, comprise a printed circuit constructed from FR4 or polyimide or another electrically insulating support material.

A reaction surface heat spreader layer 170, 180 is within or in contact with each of the heater track support layer 150 and thermal diffusion layer 160. The reaction surface heat spreader layer 170, 180 is a layer of a material with higher thermal conductivity than the thermal diffusion layer or heater track support layer. The function of the reaction surface heat spreader layers is to increase the temperature uniformity on a reaction surface 110. Each of the reaction surface heat spreader layers has a thickness Hₛ, thermal conductivity kₛ, density ρₛ, and specific heat capacity Cₛ, while the heater track support layer 150 and the thermal diffusion layer 160 each have respective thicknesses H_{B}, H_{D} thermal conductivities k_{B}, k_{D}, densities ρ_{B}, ρ_{D} and specific heat capacities C_{B}, C_{D}. In order to increase temperature uniformity while maintaining fast temperature response, the reaction surface heat spreader layer must have a greater lateral thermal conductivity and/or a lower heat capacity than the heater track support layer 150/thermal diffusion layer 160. For the heat spreader layer to have greater lateral thermal conductivity than the thermal diffusion layer, Hₛkₛ>H_{D}k_{D}. For the heat spreader layer to have a lower heat capacity than the thermal diffusion layer, HₛρₛCₛ<H_{D}ρ_{D}C_{D}. For the heater support layer, these conditions are replaced by Hₛkₛ>H_{B}k_{B} and HₛρₛCₛ<H_{B}ρ_{B}C_{B} respectively.

Each of the reaction surface heat spreader layers 170, 180 is located near to the main heater track 130. In this particular example, the reaction surface heat spreader layer 170 in the thermal diffusion layer 160 is provided at a distance of 10 μm from the upper surface of the main heater track and the reaction surface heat spreader layer 180 in the heater track support layer 150 is provided at a distance of 5 μm from the lower surface of the main heater track.

The back surface 120 is also provided with a back surface heat spreader 190 to increase temperature uniformity on the reaction surface 110.

The heat sink 200 may take any form, including the solid block shown in FIG. 1 and the individual pillars shown in FIG. 7 and described below. The back surface heat spreader 190 is particularly useful when it cannot be guaranteed that the thermal contact between the heater track support layer and the heatsink is uniform.

To achieve a good thermal contact with the main heater track, a thermal resistance×area product between the main heater track and the back surface heat spreader or the heat sink should preferably be in the range 1×10⁻⁴ to 1×10⁻² K·m²/W and more preferably in the range 3×10⁻⁴ to 3×10⁻³ K·m²/W.

The heater and heat sink (if used) can have planar or curved forms. A planar form may be preferred for ease of construction and optical monitoring of a reaction for which the heater is to be used. However other forms such as part-spherical or cylindrical are possible and these may have benefits in allowing tensioned flexible reaction cell and heater layers to make good thermal contact with each other and with the heat sink which is typically a rigid metal part.

FIG. 2 shows two examples of schematic layouts of resistive heating tracks and electrical connections in the heater 100, including the main heater track 130, the guard heater track 140 and electrical connections to these heater tracks.

As illustrated in FIGS. 2(i) and 2(ii), the main heater tracks 130 of these embodiments have serpentine configurations. Alternatively, the main heater tracks 130 may comprise a plurality of track sections both located and electrically connected in parallel. Similarly, as illustrated in FIGS. 2(i) and 2(ii), the guard heater tracks 140 of these embodiments have a serpentine configuration. As can be seen from the examples of FIG. 2, in some embodiments the guard heater track 140 does not completely surround the main heater track 130, but substantially surrounds the main heater track 130 to an extent required to achieve the effect of limiting lateral heat flow within the area of the main heater track. In many embodiments, this requirement corresponds to the guard heater track 140 surrounding more than 50% of a perimeter length of the main heater track 130.

FIG. 2(i) shows a heater with uniform track and gap width in the main heater track 130, while FIG. 2(ii) shows main heater tracks 130 with larger track and gap width in the central region 131 and smaller heater track and gap widths near the edges of the heater 133. The edge regions 133 provide increased heat output per unit area and also contain tracks oriented parallel to the edge of the heater in order to reduce thermal conductivity in the direction perpendicular to the edge of the heater and thereby reduce lateral heat flow and increase temperature uniformity in the central region 131.

A spatially separated temperature sensor could cause a time lag between temperature changes at the main heater track and temperature changes at the temperature sensor. This time lag could cause problems such as overshoot or oscillation of the heater element temperature. To avoid these problems, the main heater track is configured as a temperature sensor where the resistance of the heater element is used to determine its temperature. A metallic heater element will usually have a positive temperature coefficient of resistance while a metal oxide or semiconductor heater element will have a negative temperature coefficient. It is desirable that the magnitude of the temperature coefficient of resistance (TCR) of the heater element is large, preferably greater than 500 ppm/K, and more preferably greater than 2,500 ppm/K.

The main heater track 130 has 4-wire connections comprising electrical drive positive and negative connections 132 and 134, and voltage sense Vₛₑₙₛₑ positive and negative connections 136 and 138. Measurements of Vₛₑₙₛₑ can be used to accurately monitor of the track resistance using a circuit such as shown in FIG. 3. In combination with a known temperature coefficient of resistance, TCR, or desired temperature setpoints, of the main heater track 130, Vₛₑₙₛₑ can be used to perform temperature sensing for the main heater track 130. The use of 4-wire connections with separate contacts for driving the main heater track and sensing a voltage across the main heater track, instead of using a conventional 2-wire connection for both the driving and sensing, has the advantage of eliminating any voltage drop due to internal resistance of connections through which current is supplied to the main heater track.

The guard heater track 140 has positive and negative connections 142 and 144 to be driven independently from the main heater track 130.

FIG. 3 schematically illustrates an electronic circuit driven by supply connections Vₚₒₛ and V_{neg}, which can be used for driving the main heater track, simultaneously sensing a resistance of the main heater track, and calculating a temperature of the main heater track based on the sensed resistance. Such a control circuit may be included with the heater 100 or could be connected when the heater is in use. Referring to FIG. 3, current flows through the heater track 130 via a positive drive connection 132 and a negative drive connection 134. The heater track is provided with 4-wire contacts to allow the voltage Vₛₑₙₛₑ across the heater track to be measured using positive voltage sense contact 136 and negative voltage sense contact 138 and a voltage measuring circuit 310.

The current flowing through the heater track 130 is measured using a current sense resistor 320 with known resistance Rᵢₛₑₙₛₑ and a voltage measuring circuit 330 for measuring the voltage Vᵢₛₑₙₛₑ across the current sense resistor. The current through the heater is calculated as: Iₕₑₐₜₑᵣ=Vᵢₛₑₙₛₑ/Rᵢₛₑₙₛₑ. The resistance of the heater track 130 is then calculated as Rₕₑₐₜₑᵣ=Vₛₑₙₛₑ/Iₕₑₐₜₑᵣ. Feedback-based driving of the main heater track may then be performed according to a sequence of temperature set points.

Temperature control is implemented by determining setpoint values of Rₕₑₐₜₑᵣ corresponding to desired temperature setpoints and controlling the heater drive to meet the heater resistance setpoint values. Alternatively, temperature control may be performed continuously across a temperature range based on the known temperature coefficient of resistance, TCR. A switch 340, which may be a transistor, is turned on to measure the heater resistance and is then turned off or left on for a predetermined time interval depending on whether Rₕₑₐₜₑᵣ is above or below a currently required setpoint resistance. Alternatively, the switch 340 may driven with a pulse width modulated waveform with duty cycle selected to drive the heater with the required power. In both approaches the switch 340 is used to modulate the electrical drive to the main heater track to cycle the temperature of the reaction surface to carry out PCR amplification.

The guard heater track may be operated with closed loop control with a temperature setpoint equal to or greater than the temperature setpoint of the main heater track or the guard heater track may be operated with the same controller or on/off timing as the main heater element but with a different drive voltage which can be adjusted to optimise the temperature uniformity at a specific temperature setpoint.

Referring back to FIG. 2, sections A and B along longitudinal and transverse directions of this example configuration were simulated to determine temperature distributions as shown in FIGS. 4A and 4B. The results of these simulations illustrate the increased temperature uniformity obtained by using guard heaters.

Turning to FIGS. 4A and 4B, the results of simulations of the temperature distributions on the reaction surface were obtained from the centre of a rectangular heater area to the edge in a longitudinal direction (A) and a transverse direction (B). In each Figure, temperature is shown on the vertical axis and position along the longitudinal/transverse direction from the centre is shown on the horizontal axis. Temperature distributions are shown without guard heater (solid lines) and with guard heater (dashed lines), showing more uniform temperature distribution when guard heaters are used. The locations of the main heater and guard heater are indicated on each of FIGS. 4A and 4B. FIG. 5 shows another schematic cross-section through the heater 100 and the heatsink 200. As illustrated in FIG. 5, the main heater track 130 comprises a plurality of substantially parallel track sections having a width W_{track} spaced apart by gaps of width W_{gap}. The track sections need not be precisely parallel, so long as it is possible to define the gap width W_{gap}. The heat output from the main heater track 130 is non-uniform due to the finite width of the tracks and gaps. This is exacerbated by the need to make a thickness H_{D} of the thermal diffusion layer small in order to achieve rapid temperature changes. In this embodiment, the thickness H_{D} of the thermal diffusion layer is less than a minimum width of the track sections W_{track} or less than a minimum gap width W_{gap}. Narrower track and gap widths will increase temperature uniformity at the reaction surface, but this is limited by typical design rules, such as the requirements of PCB manufacturing techniques.

FIG. 5 also indicates a simulation region C for which the heater and heatsink were simulated. FIGS. 6A, 6B, 6C and 6D show results of simulations of the temperature along the reaction surface within the simulation region C. The simulations assumed a heater with copper tracks where W_{track} and W_{gap} are constant at 75 μm, and further assumed that the heater track support layer 150 is made of FR4 and the thermal diffusion layer 160 is made of polypropylene. The effect of increasing a heat spreader layer thickness is shown for two cases where, in each Figure, temperature on the reaction surface is shown on the vertical axis and position along the reaction surface within simulation region C, starting from the centre of the heater track portion, is shown on the horizontal axis. FIG. 6A shows the results of simulations where a reaction surface heat spreader layer 170 made of aluminium is located within the thermal diffusion layer, between the heater tracks and the reaction surface 110, at a distance of 10 μm from the heater tracks, and reaction surface heat spreader layer 180 is omitted (configuration A). FIG. 6B shows the results of simulations where a reaction surface heat spreader layer 180 made of aluminium is located within the heater track support layer, between the heater tracks and the back surface 120 of the heater, at a distance of 5 μm from the heater tracks, and reaction surface heat spreader layer 170 is omitted (configuration B). In both cases the heat spreader layer increases temperature uniformity, with thicker heat spreader layers being more effective, and configuration A is more effective than configuration B.

FIGS. 6C and 6D show simulation results in which the location of a reaction surface heat spreader layer 170 is varied. In FIG. 6C, the reaction surface heat spreader is located in the thermal diffusion layer, and the distances shown in the legend of the graph in FIG. 6C show the separation of the upper surface of the heater tracks and the heat spreader layer. In FIG. 6D, the heat spreader is located in the heater support layer and the distances shown in the legend of the graph in FIG. 6D show the separation of the lower surface of the heater tracks and the heat spreader layer. In both cases, the heat spreader is made of aluminium and has thickness 100 nm. The reaction surface heat spreader position has little impact on temperature uniformity when the heat spreader is located within the thermal diffusion layer (FIG. 6C). However when the reaction surface heat spreader is located in the heater support layer, the reaction surface heat spreader is preferably located within 15 μm of the heater in order to provide a substantial improvement in temperature uniformity (FIG. 6D). This distance scales with the track and gap width and corresponds to 20% of the minimum track and gap width as evaluated in the central region.

In FIG. 1, the heater 100 includes a back surface heat spreader 190. While this feature is not required in all embodiments of the invention, the back surface heat spreader 190 has the advantage of further improving temperature uniformity at the reaction surface 110 as demonstrated using simulations. FIGS. 7A and 7B show simulation results comparing heaters without (FIG. 7A) and with (FIG. 7B) a back surface heat spreader 190. In each Figure, the upper plot shows temperature contours from 40° C. to 60° C. on a simulated heater. The simulated heater includes heater tracks shown as a dashed line, where shorter dashes indicate the main heater track 130 and longer dashes indicate the guard heater track 140. Above the heater tracks, a reaction cell 710 is surrounded by the thermal diffusion layer 160 having the reaction surface 110, such that a temperature of the contents of the reaction cell can be controlled according to the temperature of the reaction surface. Additionally, in each Figure, the lower plot shows the temperature profile along the reaction surface (solid line, “A” in legend), in a plane cutting through the heater tracks (“B” in legend) and on the back surface of the heater (“C” in legend). The simulation of FIG. 7B assumes that the back surface heat spreader is constructed from a 12 μm thick layer of copper. In both simulations, a heat sink 200 with non-uniform thermal contact is represented by a set of three aluminium pillars, width 0.5 mm and height 1.0 mm. The geometry and results are shown for a 2D half-model, with a symmetry plane at position x=0. In both cases the heater set-point temperature is 60° C.

FIG. 8 shows simulation of the transient response of a heater as described above with a back surface heat spreader, thermocycling with 4 s cycle time using temperature setpoints of 58° C., 73° C. and 98° C. The temperature of the main heater track is shown in trace A (dashed line) and the temperature at the centre of the reaction surface is shown in trace B (solid line).

As an example, a heater according to the invention may be used for providing heat to a reaction. In such a usage, the reaction surface of the heater is located in contact with a reaction cell having a reaction volume containing a sample. In order to heat the reaction surface, the heater element is switched on, and heat generated by the heater element flows through the reaction surface into the reaction volume. If rapid cooling is required, the heater can contact a heat sink on its back surface so that when the heater element is switched off, heat flows from the reaction surface, through the heater and into the heat sink.

When the heater is applied for thermal cycling, such as for driving PCR reactions, it is advantageous for the thermal diffusion time between the heater and the sample to be small compared with the target cycle time. In general, thermal diffusion time t for a material sample is given by:

t=L²/D,

where L is a characteristic length scale of the material sample and D is the thermal diffusivity of the material. Table 1 below shows an example choice of materials for a heater according to the invention, in which the thermal diffusion time of the thermal diffusion layer is less than the reaction time for PCR, which we take as approximately 1 s for amplification of a 100 base pair DNA sequence.

Additionally, the thermal resistance of the heater track support layer R_{T} can be optimised to minimise the thermal cycling time for a given temperature profile and heatsink temperature T_{Sink} and heater power p_{Heat}. The time required for thermal cycling between a T_{LOW} and T_{HIGH} is minimised when the heating time is equal to the cooling time and this condition is satisfied when R_{T}=R_{T,Opt} as follows:

R_{T,Opt}=(T_{HIGH}+T_{LOW}−2T_{Sink})/p_{Heat}.

Table 2 (below) shows example values for heater power, optimal thermal resistance and thermal cycle time. These are shown for the case of a reaction surface with area 50 mm² and with heat capacity 0.04 J/K, cycling between 60° C. and 95° C. with a heat sink temperature of 30° C.

Table 3 (below) shows example values for heater power, optimal thermal resistance and thermal cycle time for a case where the thermal cycle includes a hold step of 1 s duration at 72° C. These are shown for the case of a reaction surface with area 50 mm² and with heat capacity 0.04 J/K, cycling between 60° C. and 95° C. with a heat sink temperature of 30° C.

FIG. 9 shows an alternative schematic layout of resistive heating tracks in a heater 100 according to the invention. In this embodiment, two main heater tracks 130 are arranged next to each other in order to heat individual respective areas of a reaction surface 110. The main heater tracks are both surrounded and separated by a guard heater track 140.

The embodiment of FIG. 9 illustrates how a heater according to the invention may be provided with a main heater track for each of a plurality of individually temperature-controlled areas of a reaction surface. The guard heater track 140 inhibits lateral heat flow and thereby increases the accuracy with which each of the individual areas of the reaction surface may be temperature-controlled.

As shown in FIG. 9, the guard heater track 140 has three connections 142, 144 and 146 such that the current and heat output per unit area may be different between and around the two main heater tracks 130. Alternatively, each main heater track 130 may be provided with a separate guard heater track 140 with two connections.

FIG. 10 shows an example preferred range of thermal resistance 1001 when a hold step is included in a thermal cycle for controlling a heater or a variable temperature reactor as described herein. The PCR cycle consists of melt, anneal and extension steps, and extension is often the most time-consuming part of the reaction and may require a hold step. In this example a hold step of 1 s duration at 72° C. is included, to allow time for extension in the PCR reaction. The time required for extension may vary, depending on the speed of the polymerase and the length of the DNA sequence being amplified. A hold step of 1 s may be appropriate for rapid amplification of DNA sequences with length in the range 100 to 150 base pairs, a length typically used for nucleic acid based diagnostic testing, and longer sequences will generally require longer extension times. The hold step duration will optimally be long enough to allow for extension but not significantly longer, otherwise it will dominate and extend the overall cycle time undesirably. The skilled person will readily see that adjustments to the hold step duration, exemplified as 1 s in the above examples, may be made without significant consequence to the overall operation.

The graph in FIG. 10 illustrates the preferred range of values of thermal resistance (shown on a logarithmic scale) to allow both low thermal cycle time (solid line) and low energy consumption per cycle (dashed line): the minimum thermal cycle time including the hold step, t_{cycle} 1004 becomes undesirably large (>5 s) when the thermal resistance is larger than the maximum preferred value 1003, while the energy consumed per cycle, E_{cycle} 1005 becomes undesirably large (>10 J) when the thermal resistance is lower than the minimum preferred value 1002. In summary, a thermal resistance×cell area product R_{T,Opt}×A_{cell} in the range 3×10⁻³ to 3×10⁻² K·m²/W is preferred for fast thermal cycling (t_{cycle}<5 s) with low energy consumption per cycle (E_{cycle}<10 J for A_{cell}=5×10⁻⁵ m²).

In the above-described embodiments, the heater is provided in an assembly with a heat sink. However, the invention is also applicable in cases where uniform heating is required, but a heat sink is not required. For example, the heat sink may be omitted for applications where a cooling time is less important.

In the above-described embodiments, the heater is provided with a guard heater track 140. However, in addition to or instead of providing the guard heater track 140, the main heater track 130 may be designed to have higher heat output near its edges and to extend beyond the reaction volume. This higher heat output effect may be achieved by increasing the density of the heater track by reducing the gap width between two or more heater track portions near the edge of the main heater track as compared to heater track portions at the centre of the main heater track. Additionally or alternatively, this effect may be achieved by increasing the resistance of the main heater track by reducing the width or height of one or more heater track portions near the edge of the main heater track as compared to heater track portions at the centre of the main heater track. The higher heat output of the heater element near its edges can compensate for lateral heat flow and provide more uniform temperature conditions across the reaction volume. Furthermore, where a heater has a reaction surface that extends significantly beyond the required reaction volume, it is possible to omit both of the guard heater track and the modifications near the edge of the main heater track.

Additionally, in the above description, comparisons are evaluated between including and omitting each of the heat spreaders. Accordingly, the reader will understand that, while preferably included, each of the heat spreaders 170, 180 and 190 may be omitted in embodiments of the invention.

TABLE 1
Example heater materials, thermal properties and layer thicknesses.

| | | Thermal | Heater support | | Heat spreader | | Heat |
|---|---|---|---|---|---|---|---|
| | | diffusion layer | rigid | flexible | reaction surface | back surface | sink |
| material | | polypropylene | FR4 | polyimide | aluminium | copper | aluminium |
| thermal conductivity | W/m/K | 0.2 | 0.29 | 0.12 | 205 | 385 | 205 |
| specific heat capacity | J/K/kg | 1920 | 950 | 1090 | 753 | 377 | 921 |
| density | kg/m³ | 946 | 1850 | 1420 | 2700 | 8960 | 2700 |
| thermal diffusivity | m²/s | 1.10E−07 | 1.65E−07 | 7.75E−08 | 1.01E−04 | 1.14E−04 | 8.24E−05 |
| thermal effusivity | W · s^{1/2}/m²/K | 603 | 714 | 431 | 20415 | 36062 | 22578 |
| thickness | m | 5.00E−05 | 4.00E−04 | 1.00E−04 | 1.00E−07 | 1.20E−05 | 1.00E−02 |
| thermal diffusion time | s | 2.27E−02 | 9.70E−01 | 1.29E−01 | 9.92E−11 | 1.26E−06 | 1.21E+00 |
| thermal resistance × unit | K · m²/W | 2.50E−04 | 1.38E−03 | 8.33E−04 | 4.88E−10 | 3.12E−08 | 4.88E−05 |
| area | | | | | | | |
| heat capacity | J/K/m² | 9.08E+01 | 7.03E+02 | 1.55E+02 | 2.03E−01 | 4.05E+01 | 2.49E+04 |

TABLE 2
Example values for heater power, optimal thermal resistance
of heater support layer, and thermal cycle time.

| Heat sink temperature, T_{Sink} | ° C. | 30 | | | | |
|---|---|---|---|---|---|---|
| Lower cycling temperature, T_{LOW} | ° C. | 60 | | | | |
| Higher cycling temperature, T_{HIGH} | ° C. | 95 | | | | |
| Reaction surface area, A_{cell} | m² | 5E−05 | | | | |
| Reactor heat capacity, h | J/K | 0.04 | | | | |
| Heater power, pₕₑₐₜ | W | 47.50 | 15.83 | 4.75 | 1.58 | 0.48 |
| Optimal thermal resistance from | K/W | 2 | 6 | 20 | 60 | 200 |
| heater to heatsink, R_{T, Opt} | | | | | | |
| Thermal resistance × area, | K · m²/W | 1E−04 | 3E−04 | 1E−03 | 3E−03 | 1E−02 |
| R_{T, Opt} × A_{cell} | | | | | | |
| Thermal time constant, h × R_{T, Opt} | s | 0.13 | 0.38 | 0.76 | 1.52 | 5.07 |
| Cooling time, t_{cool} | s | 0.10 | 0.29 | 0.59 | 1.18 | 3.92 |
| Heating time, tₕₑₐₜ | s | 0.10 | 0.29 | 0.59 | 1.18 | 3.92 |
| Minimum cycle time, t_{cycle} | s | 0.20 | 0.59 | 1.18 | 2.35 | 7.83 |
| Energy consumed per cycle, E_{cycle} | J | 2.94 | 2.94 | 2.94 | 2.94 | 2.94 |

TABLE 3
Example values for heater power, optimal thermal resistance of heater support
layer, and thermal cycle energy consumption and time, showing the preferred
design range when a hold step is included in the thermal cycle.

| Hold time, t_{HOLD} | s | 1 | | | | |
|---|---|---|---|---|---|---|
| Hold temperature, T_{HOLD} | ° C. | 72 | | | | |
| Heat sink temperature, T_{Sink} | ° C. | 30 | | | | |
| Lower cycling temperature, T_{LOW} | ° C. | 60 | | | | |
| Higher cycling temperature, T_{HIGH} | ° C. | 95 | | | | |
| Reaction surface area, A_{cell} | m² | 5E−05 | | | | |
| Reactor heat capacity, h | J/K | 0.04 | | | | |
| | | High | Preferred | | | Long |
| | | energy | design range | | | time |
| Heater power, pₕₑₐₜ | W | 47.50 | 15.83 | 4.75 | 1.58 | 0.48 |
| Optimal thermal resistance from | K/W | 2 | 6 | 20 | 60 | 200 |
| heater to heatsink, R_{T, Opt} | | | | | | |
| Thermal resistance × area, | K · m²/W | 1E−04 | 3E−04 | 1E−03 | 3E−03 | 1E−02 |
| R_{T, Opt} × A_{cell} | | | | | | |
| Minimum cycle time, t_{cycle} | s | 1.1 | 1.4 | 2.2 | 4.7 | 13.4 |
| Energy consumed during hold step, E_{HOLD} | J | 21.0 | 7.0 | 2.1 | 0.7 | 0.2 |
| Energy consumed per cycle, E_{cycle} | J | 23.9 | 9.9 | 5.0 | 3.6 | 3.1 |

1. A heater for thermocycling to carry out polymerase chain reaction (PCR) amplification, the heater comprising:
a thermal diffusion layer having a reaction surface for transferring heat to a reaction cell;
a heater track support layer having a back surface for cooling;
an electrically conductive main heater track supported between the heater track support layer and the thermal diffusion layer; and
four-terminal electrical contacts to the main heater track configured to provide electrical connection for driving the main heater track and simultaneously sensing a resistance of the main heater track,
wherein lateral dimensions of the reaction surface are greater than a thickness H of the heater, such that reaction surface area A>H².

2. A heater according to claim 1, wherein the main heater track comprises a central region comprising a plurality of substantially parallel track sections having widths Wtrack and separated by gaps of width Wgap, wherein the thickness H_{D} of the thermal diffusion layer is less than a minimum width of the track sections Wtrack or less than a minimum gap width Wgap, where Wtrack or Wgap are evaluated in the central region of the main heater track.

3. A heater according to claim 2, wherein the gap width Wgap and/or the width of the track sections Wtrack is lower for a track section near an edge of the main heater track than for a track section in the central region of the main heater track.

4. A heater according to claim 1, further comprising:
a guard heater track between the heater track support layer and the thermal diffusion layer, the guard heater track substantially surrounding the main heater track; and
two further electrical contacts to the guard heater track independent from the four-terminal electrical contacts to the main heater track.

5. A heater according to claim 1, wherein the heater track support layer has a thermal resistance×area product in the range 1×10⁻⁴ to 1×10⁻² K·m²/W.

6. The heater according to claim 1, further comprising a reaction surface heat spreader layer located in contact with or within one of the thermal diffusion layer or the heater track support layer.

7. A heater according to claim 6, wherein the reaction surface heat spreader layer is more thermally conductive, has a greater lateral thermal conductivity and has a lower heat capacity than the one of the thermal diffusion layer or the heater track support layer.

8. A heater according to claim 2, wherein the reaction surface heat spreader layer is located within the heater track support layer at a distance Ls from the main heater track, wherein Ls is less than 20% of the minimum of the heater track width Wtrack and heater gap width Wgap evaluated in the central region.

9. A heater according to claim 1, wherein a back surface heat spreader layer is located on the back surface.

10. A heater according to claim 1, further comprising a heat sink in contact with the back surface.

11. A single use consumable comprising a heater according to claim 1 and a reaction cell arranged in contact with the reaction surface.

12. A method of operating a heater according to claim 1, the method comprising driving the main heater track, simultaneously sensing a resistance of the main heater track, and calculating a temperature of the main heater track based on the sensed resistance.

13. A method according to claim 12, comprising performing feedback-based driving of the main heater track according to a sequence of temperature set points for the main heater track to cycle the temperature of the reaction surface to carry out PCR amplification.

14. A method according to claim 12, wherein the heater further comprises
a guard heater track between the heater track support layer and the thermal diffusion layer, the guard heater track substantially surrounding the main heater track; and
two further electrical contacts to the guard heater track independent from the four-terminal electrical contacts to the main heater track; and the method further comprises driving the guard heater track to provide a higher heat output per unit area than the main heater track.

15. A heater according to claim 1, further comprising a control circuit configured to drive the main heater track, simultaneously sense a resistance of the main heater track, and calculate a temperature of the main heater track based on the sensed resistance.
